(19) United States
(12) Patent Application Publication
(10) Pub. No.: US 2010/0177039 A1
(43) Pub. Date: Jul. 15, 2010

(54) Finger Indicia Input Device for Computer

(76) Inventors: Isaac Grant, La Jolla, CA (US); Donn K. Harms, Del Mar, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/685,661

(22) Filed: Jan. 11, 2010

Related U.S. Application Data
(60) Provisional application No. 61/143,780, filed on Jan. 10, 2009.

(51) Int. Cl. G06F 3/033; H04N 5/00

(52) U.S. Cl. 345/157; 348/61; 348/E05.001

(57) ABSTRACT

A device for controlling a computer to input commands using only hand motion. The device employs visually distinct indicia upon the thumb and at least one other finger of a user's hand. Using cameras or other means to capture movement of the user's hand, any contact between the thumb and a finger bearing the distinct indicia is ascertained as an input command. A laser or dot projecting pointer may be controlled using indicia in the form of a line on one finger.

### FIELD OF THE INVENTION

This application is a Continuation in Part application of U.S. Provisional Application No. 61/143,780 filed Jan. 10, 2009 which is incorporated herein in its entirety by reference.

The disclosed device relates to computer interfacing in order to initiate a response or action. More particularly it relates to a device and method of operation which allows for communicating inputs to a computer based graphic display using hand gestures. The hand gestures may be employed in combination with a glove to provide both laser pointer or optical highlighting and also common inputs such as a right-click and left-click as would normally be handled by a mouse or trackball.

### BACKGROUND OF THE INVENTION

Modern computers have replaced the mode of computer interaction using a text based input system such as DOS, with a graphic interface. Such graphic interfaces employ a cursor which is positioned upon a point in the video display wherein a button is pressed to initiate a command based on that positioning upon defined pixels within the graphic interface. Commonly, a mouse or trackball handles cursor movement and has at least two input button switches which provide commands to the computer in combination with the cursor location upon the graphic interface.

On large screen displays such as those used in meetings and the like, where the user may be a speaker, this graphic interface which requires both mouse movement and button clicking, can be a problem. Further, frequently with such large screen presentations, the user is not only changing screens, but also trying to highlight portions of the screen using a pointer of some type such as a laser-pointer. Such pointers are hand-aimed and position a small laser dot on the screen to highlight, to the audience, something in proximity to the dot. The speaker, standing in front of an audience, is tasked with concurrently changing the video being displayed, executing commands using the graphic interface, and pointing out highlights with a laser pointer. These actions must be accomplished all while speaking.

This can be a most vexing problem in that a mouse is not easily used and the hand-held replacements have buttons that must be accurately pressed and lack the ability to easily move a cursor displayed on the screen. Pressing a right-click or left-click on a hand held input device is equally challenging while the user is trying to speak and point out highlights.

As such, there exists a continual unmet need for a computer interface device which will provide the cursor movement of a mouse or trackball concurrently with the right-click and left-click switching to cause the cursor to execute commands in combination with the graphic interface. Such a device should require little dexterity and no wiring or wireless interface between the hand-operated unit and the computer. Further, such a device and method should also allow the user to easily position highlighting laser dots or facsimiles thereof on the screen during the presentation. This should be doable with the same hand as is employed for other actions which minimizes the knowledge required of the user as to any command functions or visual interface actions to initiate computer actions. Still further, such a device and method should allow for virtually any object itself to actually initiate an action once designated to a local or networked computer without any need for a mouse, pointer, keyboard or graphic interface. The object might be a three-dimensional object, a page with indicia thereon, a virtual object such as a pattern, or indicia forming a design upon a surface placed in the field of view of the component generating a digital image and communicating it to the engaged computer.

Such a device and method should ideally, solely require the user to make hand gestures to control either the cursor movement, the laser or other highlighting of video screen positions, and a plurality of input choices such as the conventional right-click and left-click input choices of a mouse and trackball. Such a device and system should also offer easy standardization and interface with the millions of installed computers and allow any user to easily employ the gestural interface.

With respect to the above, before explaining at least one preferred embodiment of the invention in detail or in general, it is to be understood that the invention is not limited in its application to the details of construction and to the arrangement of the components or the steps set forth in the following description or illustrated in the drawings. The various apparatus and methods of the invention are capable of other embodiments, and of being practiced and carried out in various ways, all of which will be obvious to those skilled in the art once the information herein is reviewed. Also, it is to be understood that the phraseology and terminology employed herein are for the purpose of description and should not be regarded as limiting.

As such, those skilled in the art will appreciate that the conception upon which this disclosure is based may readily be utilized as a basis for designing new glove-based gestural input devices for computer systems and the like, for carrying out the several purposes of the present disclosed device and method. It is important, therefore, that the embodiments, objects and claims herein, be regarded as including such equivalent construction and methodology insofar as they do not depart from the spirit and scope of the present invention.

### SUMMARY OF THE INVENTION

Computer interfaces, whether graphic or text based, generally require a working knowledge of the user in how the interface commands the computer to actually execute functions.

Graphic interfaces require a user-moved device to initiate cursor movement to various points on the screen and a subsequent input device such as a mouse button to indicate to the computer that the cursor is interfaced on the screen properly in order to execute the command associated with the pixel location.

The present invention contemplates a novel method and device that employs one or preferably a plurality of video cameras or other means to monitor the movements and gestures of the user's hand which is covered with a glove. The glove has no wires or need for wired or wireless communication with the computer system, as all inputs to the computer to run the software are provided by finger movements and gestures and combinations thereof.

The glove may be a permanent device, or a throw-away type rubber glove. The throw-away type glove will allow the device and method herein to be standardized and therefor easily implemented and used by virtually any user by simply donning the rubber glove to their hand. Thereafter, cameras and software are employed to provide the interface normally provided by a mouse, to move the cursor on a screen and to make input choices normally handled with right and left buttons on the mouse. It should be noted that a glove is described as the preferred mode of the device. However, indicia could also be painted on each finger and thumb, or finger tip type finger covers might be employed to place indicia on finger tips and the thumb.

Additionally, the device and method herein allow the user to highlight portions of the video screen with either a laser dot, or a virtual highlight formed in the screen display by simply pointing one finger at the screen. Cursor movement is handled in the same fashion and switching between the two functions may be handled without wires or switches.

The device and method employ a glove having a plurality of colors or indicia patterns on the fingers and thumb. Each finger and the thumb will have a portion which bears indicia thereon which is distinct from all the other fingers of the glove.

Software adapted to the task will employ real time video communicated to the computer of the user's hand which is captured by a plurality of cameras. The software will employ the video to move the cursor, move the highlighting dot or area, and to make inputs to operate the computer in the conventional mode of a mouse or trackball by simply tracking the user's hand and fingers and relating them to movements and actions stored in relational databases accessed by the software.

Cursor movement, and/or laser or screen highlighting, is provided by one finger of the glove being designated as a pointer. Generally, people point with the finger closest to the thumb so the device herein depicts that finger as the pointing finger. To aid the system in ascertaining where the finger is pointing, the glove will have one or a plurality of visible lines imparted to the pointing finger. The lines are easily recognizable by a camera. Using cameras which are blind to all colors but one, the lines might also be made in the single color viewable by the cameras.

From at least two viewing angles of the user's hand provided by the cameras, software will triangulate using imaginary lines to ascertain the exact point the pointing figure is pointing to on the screen, and if the pointing finger is moving. Thus, the pointing finger may either point and designate a spot on the screen for a laser highlight or virtual highlight to appear, or it may move a cursor about the screen.

Input switching or switching between modes of input is provided by the user touching the thumb to contact any other finger on the same hand in view of the cameras. The intersection of the two different types of indicia on the thumb and contacting finger, when communicated to software on the computer, will be designated as an input signal which the software may relate to a pre-chosen action. Using the thumb and four fingers, the user can easily generate four different inputs such as right-click, left-click and switching the pointing finger mode between laser/highlight and moving the cursor.

Because the system employs cameras and indicia on the glove to operate the computer, no wires or wireless connection of the glove to the computer is required. The glove need only be placed on the user's hand and viewable by the cameras. As noted, because indicia on gloves can be standardized, software may be adapted to the task to take certain actions based on ascertained finger and thumb contact which relates to stored actions on the computer. Consequently, the gloves could be sold or distributed and software employed allowing user's to all learn the same touch commands so they can operate the software independently and also know how to operate another user's software using the same commands.

The foregoing has outlined rather broadly the more pertinent and important features of the device and method herein employing a glove and indicia viewed by cameras to initiate computer actions and to operate a laser or other highlighter in order that the detailed description of the invention that follows may be better understood so that the present contribution to the art may be more fully appreciated. Additional features of the invention will be described hereinafter which form the subject of the claims of the invention. It should be appreciated by those skilled in the art that the conception and the disclosed specific embodiment may be readily utilized as a basis for modifying or designing other object oriented systems and methods for carrying out the same purposes of the present invention. It should also be realized by those skilled in the art that such equivalent constructions and methods do not depart from the spirit and scope of the invention as set forth in the appended claims.

In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is therefore an object of the present invention to provide a computer interface to initiate actions by a computer running software adapted to the task which uses a glove with individual indicia located on each or a plurality of fingers and upon the thumb to provide a means to input commands and operate software on a computer.

It is another object of this invention to provide a means for a user to place a laser highlight or a virtual highlight at any point on the display.

The foregoing has outlined some of the more pertinent objects of the invention. These objects should be construed to be merely illustrative of some of the more prominent features and applications of the intended invention. Many other beneficial results can be attained by applying the disclosed method and device in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

The accompanying drawings, which are incorporated in and form a part of this specification, illustrate embodiments of the invention and together with the detailed description serve to explain the principles of this invention.

FIG. 1 depicts a palm side view of the glove herein engaged upon the user's hand and the five different types of indicia with one type on each finger or the thumb.

FIG. 2 depicts an opposite side view of the glove herein from FIG. 1 and engaged upon the user's hand and the five different types of indicia with one type on each finger or the thumb.

FIG. 3 shows a contact of two types of indicia from a finger and the thumb which the software will recognize as an input choice such as a left-click.

FIG. 4 shows a second contact of the thumb indicia and another finger viewed by the cameras which software will recognize as a second type of input such as a right-click of a mouse.

FIG. 5 is a graphic depiction of a projected display and a motorized laser pointer.

FIG. 6 shows a rear display and laser or light projector which may be positioned in front or in back of the display and moved by pointing of the pointing finger of the glove.

FIG. 7 shows two hand-monitoring cameras which will watch the user's gloved-hand for movements of the pointing finger, and for contacts of the thumb indicia with that of any other finger indicia to indicate an input choice to the computer.

### DETAILED DESCRIPTION OF THE PREFERRED EMBODIMENTS

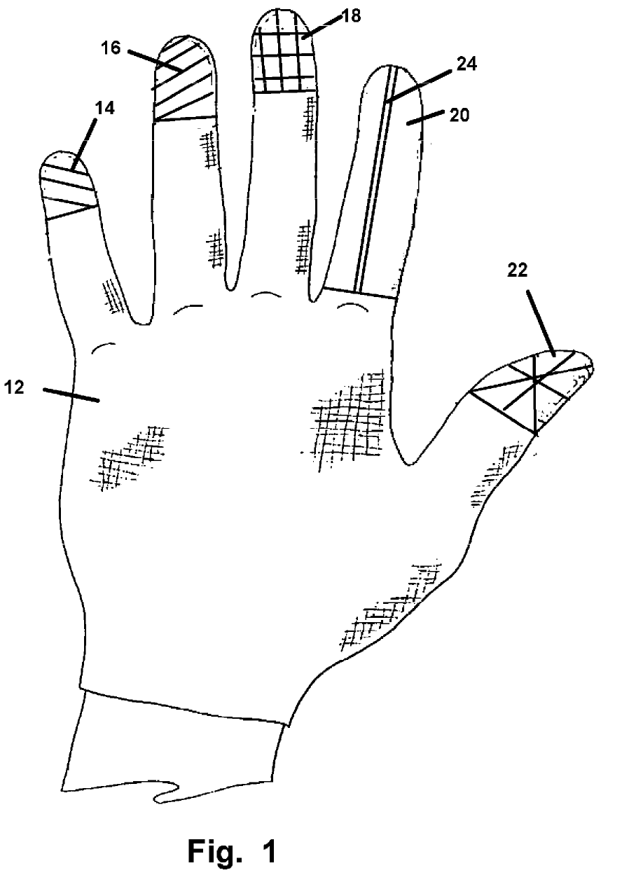

Referring now to the drawings 1-7, wherein similar parts of the invention are identified by like reference numerals, there is seen in FIG. 1, a glove 12 in a palm-side view of a typical user's hand. As shown each finger 14-20 and the thumb 22, have unique indicia positioned on a portion thereon which can either be patterns or colors that are easily recognized by the cameras and software. It need not be on a glove but might also be painted on the hand or placed on finger tip coverings which fit over the fingers.

A pointing finger 20 also has a axial line 24 formed on the glove 12. This line 24 provides a means for the cameras and software to ascertain where the pointing finger 20 is pointing on the screen. The cameras 30 and software reviewing video therefrom can ascertain a pointing spot by extending imaginary lines from the line 24. With two views, from separate cameras properly positioned, the intersection point of two imaginary lines, as shown in FIG. 7, would be the projection point, dot, or highlight 42 from a laser or other means for spot projection. If separate cursor and laser/highlight control is desired, two of the fingers may have lines 24, only with each respectively in different colors so the software may assign one task to one finger with a line 24 and cursor and highlight movement to the other.

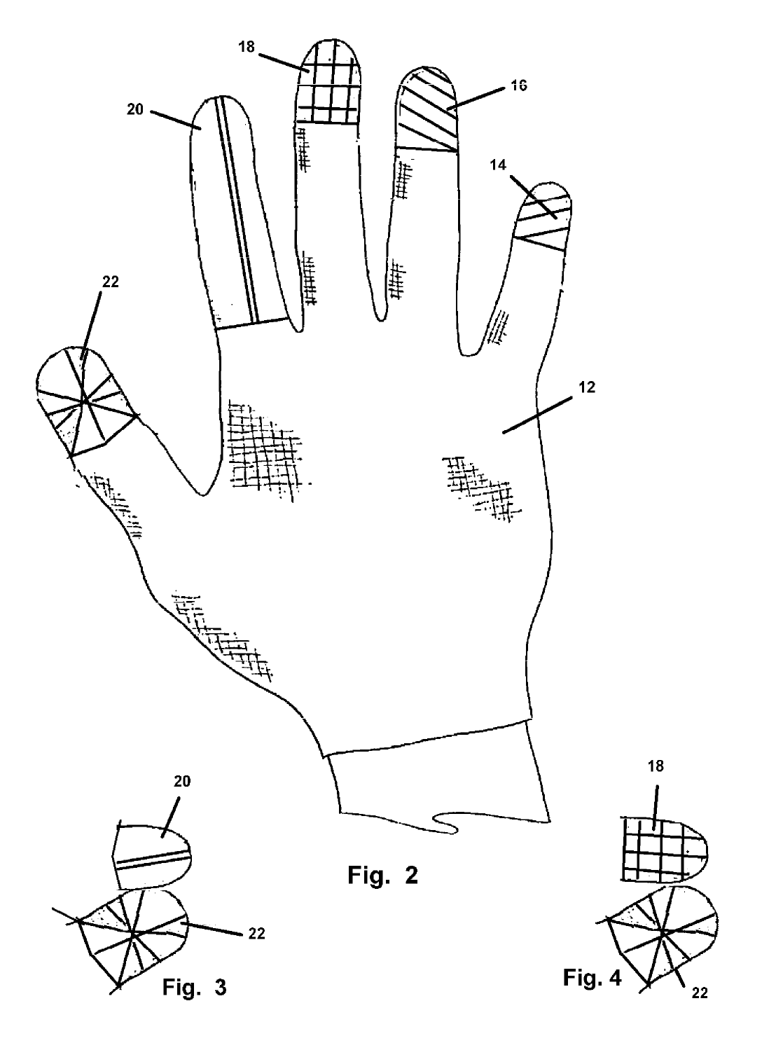

FIG. 2 depicts an opposite side view of the glove 12 herein from FIG. 1 and allows the cameras 40, such as in FIG. 7, to be positioned anywhere in the room where the cameras 40 can capture video of either the front or the back of the hand of the user. As noted, the hand itself might be covered with indicia or the fingers covered with covers bearing the indicia. A glove is the easiest mode to standardize the method herein however.

FIG. 3 shows a first contact of two types of indicia such as colors, for instance red and green, when the thumb 22 and pointing finger 20 contact by hand movement. This can be employed to input a command such as a right-click. Likewise FIG. 4 shows a second contact of the thumb 22 indicia and another finger 18 indicia which when viewed by the cameras 40, software will recognize as a second type of computer input such as a right-click of a mouse. Indicia on other fingers contacting the thumb 22 indicia, or each other may be designated as additional input choices.

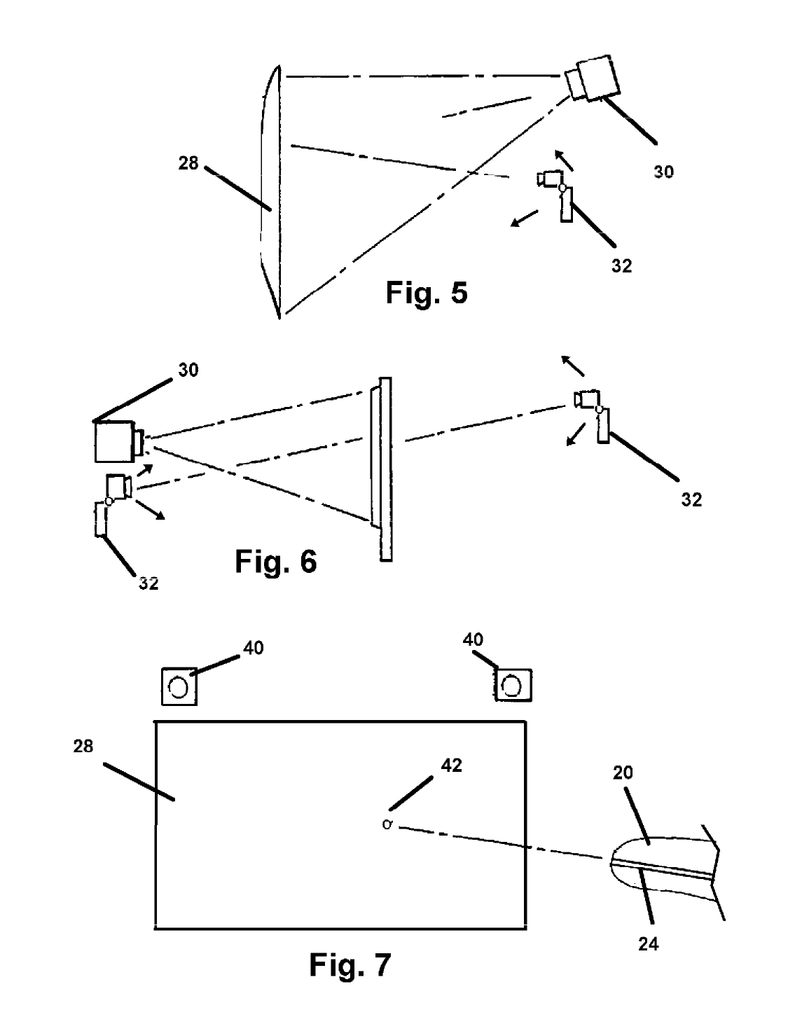

FIG. 5 is a graphic depiction of a projected display on a screen 28 using a projector 30. A motorized laser or light pointer 32 is shown. The projected highlight 42 on the screen 28 may be directed by the pointing finger 20 and the cameras 40 will ascertain where the user is pointing using software adapted to extend and intersect the line 24 viewed from two angles. The intersection point would be the same as shown in FIG. 7 where the highlight 42 is on the screen 28 and software would be employed to move the light pointer 32 to place a highlight 42 on the screen 28. The light pointer 32 may be in front of the screen or rearward as shown in FIG. 5. Further, instead of a motorized pointer 32, the highlight 42 might be virtually generated by imposing it into the projected image from the projector 30.

Finally, FIG. 7 shows at least two hand-monitoring cameras 40 which will watch the user's gloved-hand for movements of the pointing finger 20, and for the contacts of the thumb 22 indicia with that of any other finger. Also shown is the generated spot or highlight 42 on the screen 28 which may either be a cursor being moved or a highlighted portion from a light pointer 32 or a virtual generation generated or moved by the pointing finger 20 movement. One or a plurality of pointing fingers 20 can be employed on the glove 12. If one is employed, the user may switch from cursor movement to highlight positioning by the contact of a finger 16 and the thumb 22 for instance.

The system herein while described for a large screen display could easily be employed in the home or office to manipulate the cursor and input commands or manipulate a highlighter and the like and such is anticipated. Any indicia on the fingers will work so long as it is computer-recognizable by software discerning the video feed from the cameras 40 trained on the user and their hand as differentiating touching fingers.

While all of the fundamental characteristics and features of the disclosed device have been described herein, with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A device for controlling a computer to input commands comprising:
means for positioning visually distinct indicia upon the thumb and at least one other finger of a user's hand;
means to capture electronic video of said hand;
software running upon a computer, said software adapted to ascertain a contact between said indicia on said thumb and said indicia positioned on at least one other finger of said user's hand, achieve a contact with each other; and
said software configured to execute a computer command upon ascertaining said contact, whereby said user can input said command to said computer without a conventional mouse or input device.

2. The device for controlling a computer of claim 1, additionally comprising:
said visually distinct indicia positioned upon said user's thumb, and a plurality of said fingers of said user's hand;
respective individual said contacts being ascertained by said software for a respective contact between said indicia on said thumb, and each respective finger; and
said software configured to execute separate respective computer commands for each respective contact ascertained between said user's thumb, and an individual said finger bearing respective said visually distinct indicia.

3. The device for controlling a computer to input commands of claim 1, additionally comprising:
said visually distinct indicia positioned upon said finger also including an axial line running a length along said finger;
said means to capture electronic video capturing said electronic video from a plurality of angles relative to said user;
said software configured to extend imaginary lines from said axial line as viewed by each of said plurality of angles;
said software determining an intersection point of said imaginary lines and ascertain a highlight point; and
means to project said highlight point substantially at said intersection point, whereby a pointing of said finger bearing said axial line, by said user, positions said highlight point. plurality of said

4. The device for controlling a computer to input commands of claim 2, additionally comprising:
said visually distinct indicia positioned upon said finger also including an axial line running a length along said finger;
said means to capture electronic video capturing said electronic video from a plurality of angles relative to said user;
said software configured to extend imaginary lines from said axial line as viewed by each of said plurality of angles;
said software determining an intersection point of said imaginary lines and ascertain a highlight point; and
means to project said highlight point substantially at said intersection point, whereby a pointing of said finger bearing said axial line, by said user, positions said highlight point.

5. The device for controlling a computer to input commands of claim 1, wherein said means for positioning visually distinct indica upon the thumb and at least one other finger of a user's hand comprises one of a group of covers engageable over said finger and said thumb, said group including a glove and covers adapted to slide upon the distal end of said finger and said thumb.

6. The device for controlling a computer to input commands of claim 3, wherein said means for positioning visually distinct indica upon the thumb and at least one other finger of a user's hand comprises one of a group of covers engageable over said finger and said thumb, said group including a glove and covers adapted to slide upon the distal end of said finger and said thumb.

7. The device for controlling a computer to input commands of claim 2, wherein said means for positioning visually distinct indicia upon the thumb and a plurality of fingers of a user's hand comprises one of a group of covers engageable over said fingers and said thumb, said group including a glove and covers adapted to slide upon the distal end of said finger and said thumb.

8. The device for controlling a computer to input commands of claim 4, wherein said means for positioning visually distinct indicia upon the thumb and a plurality of fingers of a user's hand comprises one of a group of covers engageable over said fingers and said thumb, said group including a glove and covers adapted to slide upon the distal end of said finger and said thumb.

9. A device for controlling a computer to project a highlight point on a screen or object comprising:
means to position visually distinct indicia upon a finger of a user's hand;
said indicia including an axial line running a length along said finger;
means to capture electronic video of said finger from a plurality of angles relative to said user;
said software configured to extend imaginary lines from said axial line as viewed relative from each of said plurality of angles;
said software determining an intersection point of said imaginary lines and ascertaining a highlight point; and
means to project said highlight point substantially at said intersection point, whereby a pointing of said finger bearing said axial line, by said user, positions said highlight point.

10. A device for controlling a computer to project a highlight point on a screen or object of claim 9 additionally comprising:
said means to position visually distinct indicia upon a finger of a user's hand comprises one of a group of covers engageable over said finger, said group including a glove and a finger cover adapted to slide upon the distal end of said finger.
